(19) United States
(12) Patent Application Publication
(10) Pub. No.: US 2010/0269664 A1
(43) Pub. Date: Oct. 28, 2010

(54) SERVO POUCH KNIFE ASSEMBLY

(76) Inventor: Mike Majchrowski, Palmetto, FL (US)

Correspondence Address: KF ROSS PC, 5683 RIVERDALE AVENUE, SUITE 203 BOX 900, BRONX, NY, 10471-0900, US

(21) Appl. No.: 12/428,048

(22) Filed: Apr. 22, 2009

(51) Int. Cl. B26D 7/26

(52) U.S. Cl. 83/821

(57) ABSTRACT

The invention relates to a servo knife assembly (1) for cutting web material. The servo knife assembly (1) comprises
a frame assembly (2) having a fixed blade (3) and a moveable blade (4),
a base assembly (5) for linear adjustment of changing pouch lengths,
a servo motor and gear box assembly (6) providing actuation, and
a crank and linear bearing assembly (7,8), the crank and linear bearing assembly (7,8) drives the moveable blade (4) for cutting operation, wherein
the crank and linear bearing assembly (7,8) comprises at least a crank arm (16) and linear bearing means (13f, 13h) guiding the moveable blade (4), wherein
the crank motion is transferred to the moveable blade (4) thru the bearing mounted crank arm (16), such that the moveable blade (4) moves in a linear motion relative to the fixed blade (3).

The new servo pouch knife assembly (1) uses a unique crank method to translate the rotary motion of a servo motor and gearbox, into a high speed and highly accurate linear motion to cycle the knife blades in and out to cut the web material off during the machine swell cycle.

### FIELD OF THE INVENTION

The present invention relates to pouch handling machines in which a basic pouch is formed from a roll of pouch web material in the pouch making section of an intermittent motion form-fill-and-seal machine or in a dedicated bag maker, it is folded, sealed perpendicular to make the side sealed, and is often sealed along the fold to reinforce the bottom seal. It can be folded and sealed in many various configurations to create a string of open top pouches that are required to be cut from the roll. A knife assembly is used to cut the web material for example at the perpendicular sealing.

Known knife assemblies create a guillotine action having a shear cutting action which is less reliable, requires high forces and creates high wear on the blades and drive components.

### OBJECT OF THE INVENTION

The general aim of the present invention is to provide a new and improved knife assembly creating a high reliable scissor action reducing wear and tear of the machine, and which extends the life of the knife blades, whereby wear on the knife drive and related components is reduced.

According to the invention, the servo knife assembly consists of several basic parts: A frame assembly preferably having all components mount into, a base assembly that allows linear adjustment to change pouch lengths, a servo motor and gearbox assembly to provide the actuation, and a crank and linear bearing assembly that drives the blades for the pouch cutting operation. The new servo pouch knife assembly uses a unique crank method to translate the rotary motion of a servo motor and gearbox, into a high speed and highly accurate linear motion to cycle the knife blades in and out to cut the web material off during the machine swell cycle.

In a preferred embodiment the crank assembly also has a manual handle, so that during setup the operator can override the servo system to manually cut off web material.

The assembly, preferably the crank and linear bearing assembly creates a reciprocating motion of the crank arm. In a preferred embodiment the crank arm is designed in the kind of a con rod. It is absolutely in the sense of the invention, that a planetary gear set transforms the rotary motion of the servo motor crank into a reciprocating motion of the crank arm. The reciprocating motion of the crank arm allows the servo motor and gearbox to continually cycle in the same direction, never needing to stop or reverse, greatly reducing the loading and wear on the drive components. Advantageously the servo motor and gear box assembly is located perpendicular to the crank arm.

When the servo motor and gear box rotates, this simple crank motion is transferred to the moveable knife plate thru the use of a preferably precision bearing mounted crank arm. The moveable blade is mounted securely on two linear bearing means allowing accurate and repeatable motion. The linear bearing means are preferably spaced mounted in a longitudinal direction of the moveable blade, i.e. one of the linear bearing means is located at a foot area of the moveable blade whereby the other one is mounted opposed to the foot area mounted one at the head area of the moveable blade.

As the crank turns for example in clock-wise rotation it moves the moveable knife blade back and forth causing the moveable knife blade, which preferably is spring loaded against the front edge of the fixed knife blade, to move across the fixed blade cutting the web. Natural the crank can turn for example in counter clock-wise rotation. The crank continues rotation in a continuous motion, whereby the speed can be adjusted to match the cycling of the machine. The crank and knife motion advantageously never needs to stop during the cycle.

This ability to continuously operate reduces the wear and tear on the machine, extends the life of the knife blades, and reduces wear on the knife drive and related components. This added with the accuracy of the linear bearings produces a smooth and quiet operation. The configuration of the knife blades allows a scissor action to occur between the two blades while operating in a purely linear motion.

The fixed blade is presented at an angle to the moveable blade. A toe extends from the moveable blade across the base of the fixed blade face to assure continuous contact between the two blades. The moveable blade is retained against the fixed blade by the use of a series of precision springs to keep a constant pressure at the cut point as the two blades move against each other i.e. the moveable blade moves relative to the fixed blade. This concentrates the force at the one cut point creating a smooth and clean cut.

In a preferred embodiment, the linear bearing means comprises a first guiding element and a second guiding element, whereby the first guiding element is secured to the moveable blade, and whereby the second guiding element is mounted to a frame element of the frame assembly.

Further the moveable blade can consist of two parts, comprising a guiding plate and a knife plate, whereby the knife plate has slotted holes in which threatened bolts, which are mounted to the guiding plate, engage, such that the knife plate is adjustable relative to the guiding plate and to the fixed blade.

Advantageously the second guiding element has at least one groove engaged by a corresponding nose of the first guiding element. Preferably the second guiding element has two grooves located at opposite sides, which are engaged by the corresponding nose respectively.

The linear motion of the moveable blade is translated to a single point of contact between the fixed and the moveable blade which slides up the two blades as the moveable blade translates across the fixed blade face. This creates a scissor action between the two blades rather then a guillotine action as known knife assemblies according to the state of the art do, which create a shear cutting action which is less reliable, requires higher forces and creates more wear on the blades and the drive components.

This and other objects and advantages of the invention will become more apparent form the following detailed description when taken in conjunction with the accompanying drawings.

### BRIEF DESCRIPTION OF THE DRAWINGS

FIG. 1 is a perspective view of the new servo knife assembly,

FIG. 2 is a side view on a moveable blade acted by motor means connected to a crank arm,

FIG. 3 shows a caused motion step-by-step,

FIG. 4 shows a fixed blade presented at an angle to a moveable blade,

FIG. 5 shows a perspective view of the knife assembly in a fully opened position, and

FIG. 6 shows a perspective view of the knife assembly in a fully closed position.

### DETAILED DESCRIPTION OF THE PREFERRED EMBODIMENT

On not in detail described pouch handling machines in which a basic pouch is formed from a roll of pouch web material in the pouch making section of an intermittent motion form-fill-and-seal machine or in a dedicated bag maker, it is folded, sealed perpendicular to make the side sealed, and is often sealed along the fold to reinforce the bottom seal. It can be folded and sealed in many various configurations to create a string of open top pouches that are required to be cut from the roll. A knife assembly is used to cut the web material for example at the perpendicular sealing. The invention relates to a servo knife assembly which is described in detail.

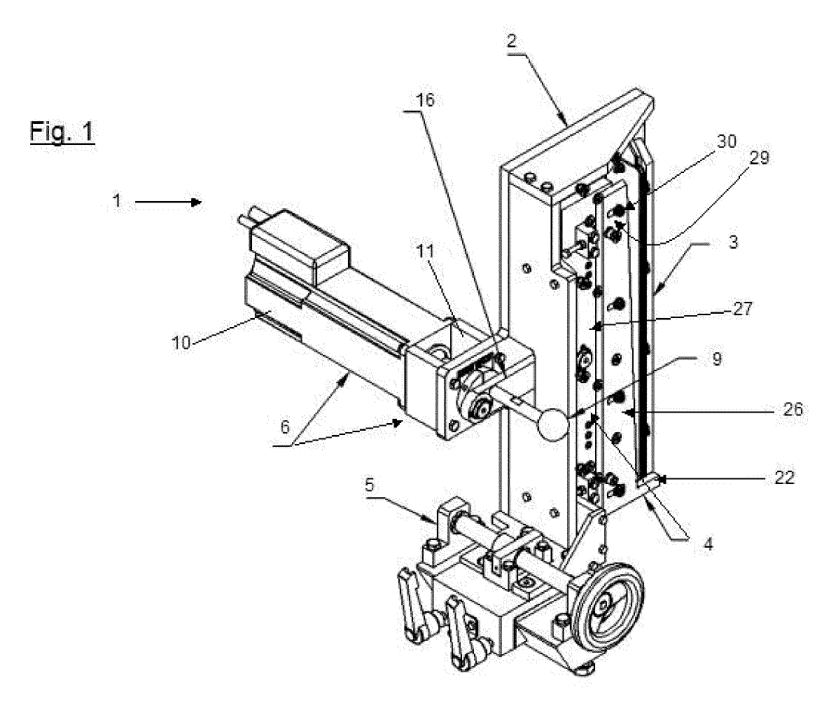

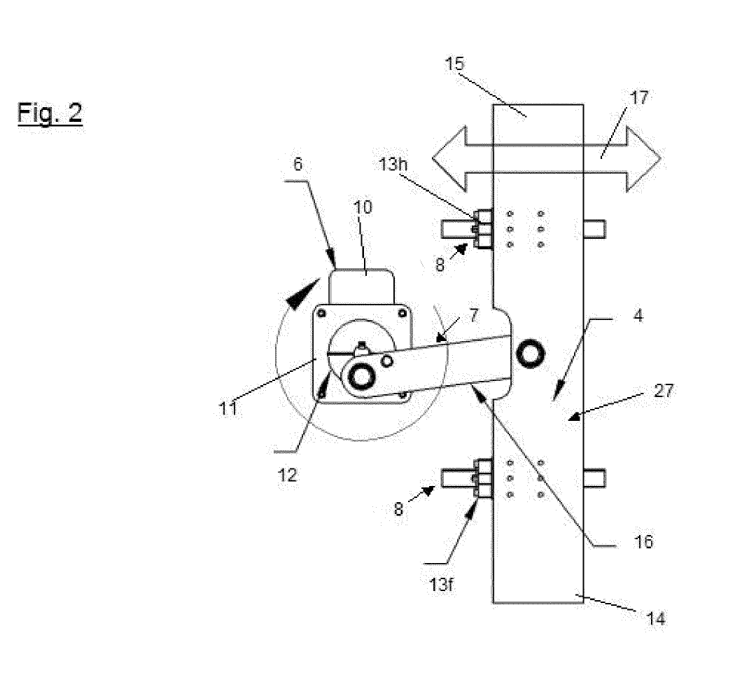

FIG. 1 shows a servo knife assembly 1 comprising a frame assembly 2 comprising at least a fixed blade 3 and a moveable blade 4, a base assembly 5 that allows linear adjustment to change pouch lengths, a servo motor and gearbox assembly 6 to provide the actuation, and a crank and linear bearing assembly 7 and 8 (see FIG. 2) that drives the moveable blade 4 for the pouch cutting operation. The crank assembly 7 also has a manual handle 9 so that during setup the operator can override the servo system to manually cut off web material. The reciprocating motion of the crank arm allows the servo motor and gearbox 6 to continually cycle in the same direction, never needing to stop or reverse, greatly reducing the loading and wear on the drive components.

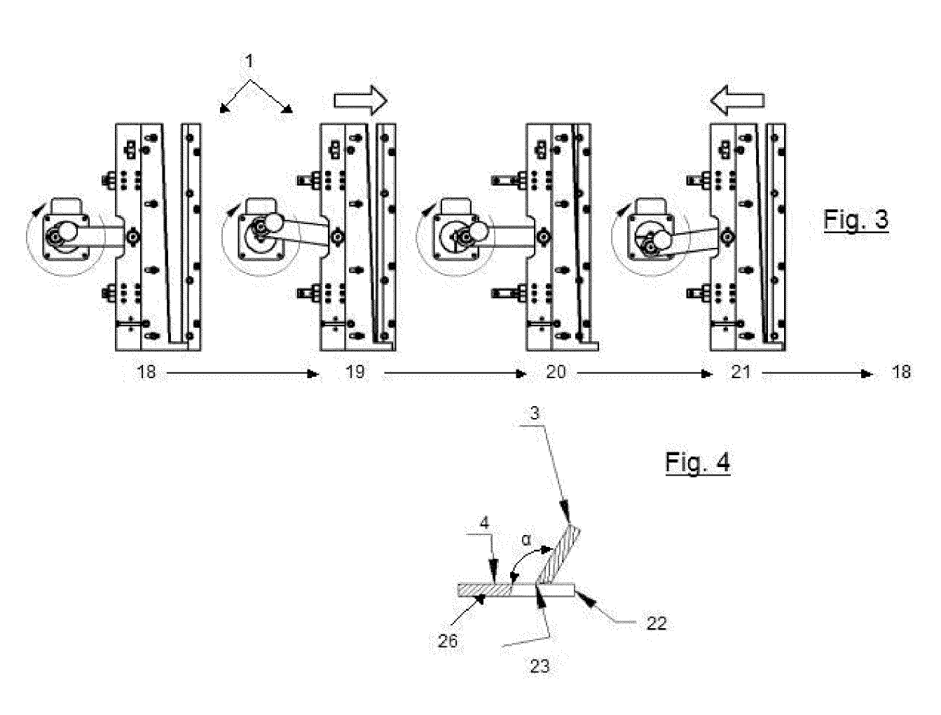

The servo motor and gear box assembly 6 comprises a servo motor 10 and a gear box 11. The servo motor 10 drives a crank 12 of the gear box 11 in a rotary motion in a clock-wise rotation as shown in the FIGS. 2 and 3

FIG. 2 shows a single view on the moveable blade 4 guided in two linear bearing means 13f, 13h. One of the linear bearing means 13f is located at a foot area 14 of the moveable blade 4, whereby the other one 13h is spaced mounted to the foot area linear bearing means 13f at a head area 15 of the moveable blade 4. The crank arm 16 is mounted to the crank 12 and opposed secured to the moveable blade 4 between the two linear bearing means 13f and 13h. This causes accurate and repeatable motion of the moveable blade 4 as indicated by the shown double arrow 17 in FIG. 2.

When the servo motor and gear box rotates, the crank motion is transferred to the moveable blade 4 causing a linear motion of the moveable blade 4.

As the crank 12 turns as shown clock-wise, the crank arm 16 moves the moveable blade 4 back and forth causing the moveable blade 4 against the edge of the fixed knife blade 3 to move across the fixed blade 3 cutting the web as shown in FIG. 3.

In step 18 of FIG. 3 the knife assembly is fully opened. In step 19 the moveable blade 4 is moving directed to a fully closed position, which is shown in step 20, whereby afterwards the moveable blade 4 moves back (step 21) into the fully opened position. During all steps the crank 12 continues to rotate in a continuous motion, whereby the speed can be adjusted to match the cycling of the machine. The crank 12 and the moveable blade 4 never needs to stop during the cycle. This ability to continuously operate reduces the wear and tear on the machine, extends the life of the knife blades, and reduces wear on the knife drive and related components. This added with the accuracy of the linear bearings produces a smooth and quiet operation. The configuration of the knife blades allows a scissor action to occur between the two blades 3 and 4 while operating in a purely linear motion.

As shown in FIG. 4 the fixed blade 3 is presented at an angle α to the moveable blade 4. According to the plane of view of FIG. 4 the angle α is an obtuse angle. A toe 22 extends from the moveable blade 4 across the base of the fixed blade face to assure continuous contact between the two blades 3 and 4. The moveable blade 4 is retained against the fixed blade 3 by the use of a series of not shown precision springs to keep a constant pressure at the cut point 23 as the two blades 3 and 4 move against each other. This concentrates the force of the spring at the one cut point 23 creating a smooth and clean cut.

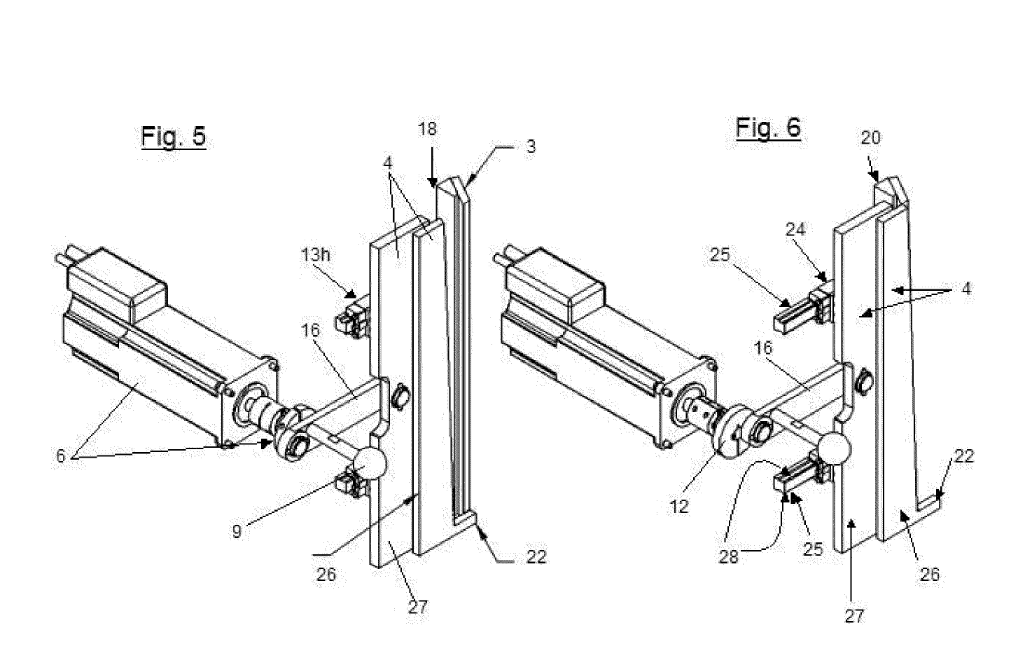

FIGS. 5 and 6 show the steps 18 (fully opened) and 20 (fully closed) according to FIG. 3.

The linear motion of the moveable blade 4 is translated to a single point of contact between the fixed and the moveable blade 3 and 4 which slides up the two blades as the moveable blade 4 translates across the fixed blade face. This creates a scissor action between the two blades 3 and 4 rather then a guillotine action as known knife assemblies do, which creates a shear cutting action which is less reliable, requires higher forces and creates more wear on the blades and the drive components.

As best shown in FIG. 6, the linear bearing means 13f and 13h each comprises a first guiding element 24 and a second guiding element 25. The first guiding element 24 is secured to the moveable blade 4, whereby the second guiding element 25 is mounted to a not shown frame element. As one can see in FIGS. 1 and 6 the moveable blade 4 consists of a knife plate 26 having the cutting edge and a guiding plate 27. The knife plate 26 is mounted to the guiding plate 27, whereby the crank arm 16 and the first guiding elements 24 are mounted to the guiding plate 27. The knife plate 26 comprises the toe 22. The second guiding element 25 has a groove 28 located on opposing sides of the second guiding element 25 respectively, in which a not visible nose of the first guiding element 24 engages respectively for guiding the moveable blade 4 in the accurate linear manner. In the preferred embodiment the groves 28 are located at the upper and the lower side of the second guiding element 25, relating to the plane of view.

As one can see in FIG. 1 the knife plate 26 has slotted holes 29 in which threaded bolts engage for adjusting the relative position of the knife plate 26 to the guiding plate 27 as well as to the fixed blade 3. In the adjusted position the knife plate 26 is secured by nuts 30.

### REFERENCE

1 Servo knife assembly
2 Frame assembly
3 fixed blade
4 moveable blade
5 base assembly
6 servo and gear box assembly
7 crank and
8 linear bearing assembly
9 manual handle
10 servo motor
11 gear box
12 crank
13 linear bearing means (f,h)
14 foot area
15 head area
16 crank arm
17 double arrow
18 step (fully open)
19 step
20 step (fully closed)
21 step
22 toe
23 cut point
24 first guiding element
25 second guiding element
26 knife plate
27 guiding plate
28 groove
29 slotted holes
30 nuts

I claim:

1. A servo knife assembly comprising
a frame assembly having a fixed blade and a moveable blade,
a base assembly for linear adjustment of changing pouch lengths,
a servo motor and gear box assembly providing actuation, and
a crank and linear bearing assembly, the crank and linear bearing assembly drives the moveable blade for cutting operation, wherein
the crank and linear bearing assembly comprises at least a crank arm and linear bearing means guiding the moveable blade, wherein
the crank motion is transferred to the moveable blade thru the bearing mounted crank arm, such that the moveable blade moves in a linear motion relative to the fixed blade.

2. The servo knife assembly according to claim 1, wherein the crank assembly comprises a manual handle.

3. The servo knife assembly according to claim 1, wherein the moveable blade is mounted securely on two linear bearing means.

4. The servo knife assembly according to claim 1, wherein the moveable blade is spring loaded.

5. The servo knife assembly according to claim 1, wherein the fixed blade is presented at an angle to the moveable blade, wherein a toe extends from the moveable blade across the base of the fixed blade face.

6. The servo knife assembly according to claim 1, wherein one of the linear bearing means is located at a foot area of the moveable blade, whereby another one of the linear bearing means is space mounted to the foot area mounted one at a head area of the moveable blade.

7. The servo knife assembly according to claim 1, wherein the crank of the crank and gear box assembly rotates in a clock-wise rotation.

8. The servo knife assembly according to claim 1, wherein the crank of the crank and gear box assembly rotates in a counter clock-wise rotation.

9. The servo knife assembly according to claim 1, wherein the fixed blade is presented at an angle to the moveable blade.

10. The servo knife assembly according to claim 1, wherein the linear bearing means comprises a first guiding element and a second guiding element, whereby the first guiding element is secured to the moveable blade, and whereby the second guiding element is mounted to a frame element.

11. The servo knife assembly according to claim 1, wherein the moveable blade comprises a guiding plate and a knife plate, whereby the knife plate has slotted holes in which threatened bolts, which are mounted to the guiding plate engage, such that the knife plate is adjustable relative to the guiding plate and to the fixed blade.

12. The servo knife assembly according to claim 10, wherein the second guiding element has at least one groove engaged by a corresponding nose of the first guiding element.
